(19) United States
(12) Patent Application Publication
(10) Pub. No.: US 2025/0265588 A1
(43) Pub. Date: Aug. 21, 2025

(54) INFORMATION PROCESSING BASED ON TARGET LIMB INFORMATION

(71) Applicant: TENCENT TECHNOLOGY (SHENZHEN) COMPANY LIMITED, Shenzhen (CN)

(72) Inventors: Runzeng GUO, Shenzhen (CN); Shaoming WANG, Shenzhen (CN); Kai XIA, Shenzhen (CN); Jiayu HUANG, Shenzhen (CN); Yaode HUANG, Shenzhen (CN); Zhongfang LV, Shenzhen (CN); Wen GE, Shenzhen (CN); Hongda LIU, Shenzhen (CN); Jiefu ZHENG, Shenzhen (CN); Xukang PENG, Shenzhen (CN); Xiaojie CHEN, Shenzhen (CN); Wei ZHAO, Shenzhen (CN); Zhiqiang ZHANG, Shenzhen (CN); Jun WANG, Shenzhen (CN); Shouhong DING, Shenzhen (CN); Ruixin ZHANG, Shenzhen (CN); Shiyou SUN, Shenzhen (CN); Jinkun HOU, Shenzhen (CN)

(73) Assignee: TENCENT TECHNOLOGY (SHENZHEN) COMPANY LIMITED, Shenzhen, GD (CN)

(21) Appl. No.: 19/204,425

(22) Filed: May 9, 2025

Related U.S. Application Data
(63) Continuation of application No. PCT/CN2024/080132, filed on Mar. 5, 2024.

(30) Foreign Application Priority Data
Apr. 18, 2023 (CN) 202310458279.7

(51) Int. Cl. G06Q 20/40; G06F 3/04842; G06V 10/77; G06V 10/80; G06V 40/12; G06V 40/14; G06V 40/20

(52) U.S. Cl. CPC G06Q 20/40145; G06F 3/04842; G06V 10/7715; G06V 10/80; G06V 40/1365; G06V 40/14; G06V 40/28; G06V 2201/07

(57) ABSTRACT

In a method for information processing, target limb information and user identification information are acquired. Customized limb configuration information that matches the user identification information is acquired. The target limb information is matched with reference limb information in the customized limb configuration information. A target object is selected according to the reference limb information. Biometric information that matches the user identification information is acquired. An operation is performed with the target object based on the biometric information. Apparatus and non-transitory computer-readable storage medium counterpart embodiments are also contemplated.

### RELATED APPLICATIONS

The present application is a continuation of International Application No. PCT/CN2024/080132, filed on Mar. 5, 2024, which claims priority to Chinese Patent Application No. 202310458279.7, filed on Apr. 18, 2023. The entire disclosures of the prior applications are hereby incorporated by reference.

### FIELD OF THE TECHNOLOGY

This disclosure relates to the field of computer technologies including information processing.

### BACKGROUND OF THE DISCLOSURE

With the development of science and technology, intelligent devices are increasingly widely applied. For example, for an application scenario of item purchase, an item interface may be displayed by using a touch display screen on an intelligent device, and then a user needs to manually touch the item interface displayed on the display screen, to perform an operation such as sliding or clicking the item. After a to-be-purchased item is selected, payment is manually touched and clicked. The manners of purchasing items by touching all require the user to manually interact on the display screen. On the one hand, frequent use of the touch display screen may accumulate grease and dirt on a surface of the screen, affecting definition, a reaction speed, and the like of the screen. On the other hand, the display screen may be used by many people. If not properly cleaned and disinfected, the display screen easily causes spread of viruses and bacteria, thereby spreading diseases, and also causing cross-contamination, especially public intelligent devices that sell items in public places such as shopping malls, airports, and hospitals. Therefore, the manners of purchasing items by touching have low hygiene levels and low purchasing efficiency.

### SUMMARY

Embodiments of this disclosure include a method and an apparatus for information processing, an electronic device, a non-transitory computer-readable storage medium, and a computer program product.

Technical solutions of embodiments of this disclosure may be implemented as follows.

An embodiment of this disclosure provides a method for information processing. In the method, target limb information and user identification information are acquired. Customized limb configuration information that matches the user identification information is acquired. The target limb information is matched with reference limb information in the customized limb configuration information. A target object is selected according to the reference limb information. Biometric information that matches the user identification information is acquired. An operation is performed with the target object based on the biometric information.

An embodiment of this disclosure provides a method for information processing method. In the method, target limb information is obtained based on collecting external limb information by using an information collector of a palm scanning device. Customized limb configuration information matching the user identification information is acquired by using an application of the palm scanning device when user identification information corresponding to the target limb information exists. Target limb information is matched with reference limb information in the customized limb configuration information. In response to the limb information matching the target limb information, a target object is selected from selectable objects provided by the palm scanning device. Palm information matching the user identification information is collected by using the information collector, in In response to a message indicating successful verification on the palm information, payment information corresponding to the target object is acquired by using the palm scanning device. A payment operation is performed based on the payment information.

An embodiment of this disclosure provides an apparatus for information processing. The apparatus includes processing circuitry that is configured to acquire target limb information and user identification information, acquire customized limb configuration information that matches the user identification information, match the target limb information with reference limb information in the customized limb configuration information, select a target object according to the reference limb information, acquire biometric information that matches the user identification information, and perform an operation with the target object based on the biometric information.

An embodiment of this disclosure provides an apparatus for information processing. The apparatus includes processing circuitry that is configured to obtain target limb information based on collecting external limb information by using an information collector of a palm scanning device, when user identification information corresponding to the target limb information exists, acquire, by using an application of the palm scanning device, customized limb configuration information matching the user identification information, match the target limb information with reference limb information in the customized limb configuration information, select, in response to the limb information matching the target limb information, a target object from selectable objects provided by the palm scanning device, collect, by using the information collector, palm information matching the user identification information, and acquire, in response to a message indicating successful verification on the palm information, payment information corresponding to the target object by using the palm scanning device, and perform a payment operation based on the payment information.

An embodiment of this disclosure provides a device, including a memory and a processor. The memory is configured to store executable instructions. The processor is configured to implement, when executing the executable instructions stored in the memory, the method for information processing provided in embodiments of this disclosure.

An embodiment of this disclosure provides a non-transitory computer-readable storage medium, storing instructions which when executed by a processor cause the processor to perform the method for information processing provided in embodiments of this disclosure. An embodiment of this disclosure provides a computer program product,

including a computer program or computer-executable instructions. When the computer program or the computer-executable instructions are executed by a processor, the method for information processing provided in embodiments of this disclosure is implemented.

According to the embodiments of this disclosure, the target limb information may be acquired, the user identification information corresponding to the target limb information may be acquired, and the custom limb configuration information matching the user identification information may be acquired. Then, the target limb information may be matched with the limb information included in the custom limb configuration information, to obtain the limb information matching the target limb information. The target object may be selected according to the limb information matching the target limb information. In this case, the biological information matching the user identification information may be acquired, and a corresponding operation is performed on the target object based on the biological information. The computer device acquires the target limb information without contact between a user and the computer device, and the target object may be selected by matching the corresponding custom limb configuration information only based on the target limb information, thereby effectively reducing a quantity of touch operations performed by the user on the computer device, improving a hygiene level, and improving efficiency of information processing.

### BRIEF DESCRIPTION OF THE DRAWINGS

FIG. 1 is a schematic diagram of a scenario to which an information processing method is applied according to an embodiment of this disclosure.

FIG. 2 is a schematic flowchart of an information processing method according to an embodiment of this disclosure.

FIG. 3 is a schematic diagram of item selection according to an embodiment of this disclosure.

FIG. 4 is a schematic diagram of video selection according to an embodiment of this disclosure.

FIG. 5 is a schematic diagram of text selection according to an embodiment of this disclosure.

FIG. 6 is a schematic diagram of item purchase according to an embodiment of this disclosure.

FIG. 7 is a schematic diagram of video playback according to an embodiment of this disclosure.

FIG. 8 is a schematic diagram of text copy according to an embodiment of this disclosure.

FIG. 9 is another schematic flowchart of an information processing method according to an embodiment of this disclosure.

FIG. 10 is a schematic diagram of an information processing architecture according to an embodiment of this disclosure.

FIG. 11 is another schematic flowchart of an information processing method according to an embodiment of this disclosure.

FIG. 12 is another schematic flowchart of an information processing method according to an embodiment of this disclosure.

FIG. 13 is another schematic flowchart of an information processing method according to an embodiment of this disclosure.

FIG. 14 is a schematic diagram of an information processing apparatus according to an embodiment of this disclosure.

FIG. 15 is another schematic diagram of an information processing apparatus according to an embodiment of this disclosure.

FIG. 16 is a schematic structural diagram of a computer device according to an embodiment of this disclosure.

### DESCRIPTION OF EMBODIMENTS

To make the objectives, technical solutions, and advantages of this disclosure clearer, the following describes this disclosure in further detail with reference to the accompanying drawings. The described embodiments are not to be considered as a limitation on this disclosure. Other embodiments are within the scope of this disclosure.

Embodiments of this disclosure provide an information processing method and apparatus, a computer device, a storage medium, and a computer program product.

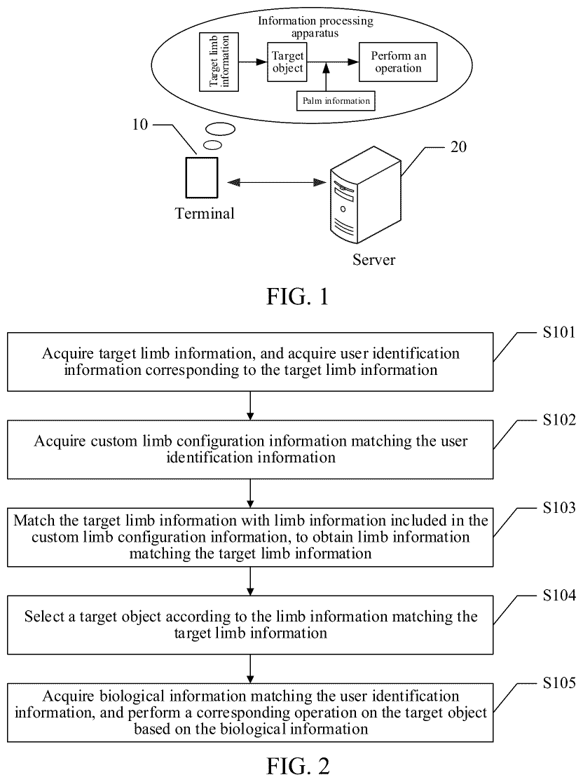

Referring to FIG. 1, FIG. 1 is a schematic diagram of a scenario to which an information processing method is applied according to an embodiment of this disclosure. The information processing method may be applied to an information processing apparatus. The information processing apparatus may specifically be integrated into a terminal 10. The terminal 10 may be a mobile phone, a computer, a vending machine, or the like. The terminal 10 may be directly or indirectly connected to the server 20 in a wired or wireless communication manner, which is not limited in this disclosure herein. The server 20 may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform, but is not limited thereto.

The terminal 10 may be configured to acquire target limb information, acquire user identification information corresponding to the target limb information, and acquire custom limb configuration information matching the user identification information. For example, custom limb configuration information corresponding to different users may be different. Then, the target limb information may be matched with limb information included in the custom limb configuration information, to obtain limb information matching the target limb information. The target object (such as an item, a video, or text) may be selected according to the limb information matching the target limb information. In this case, biological information matching the user identification information may be acquired, and a corresponding operation is performed on the target object based on the biological information. For example, payment information corresponding to the target object is acquired, and a payment operation is performed, or a playback file corresponding to the target object is acquired and played back, or a copy operation is performed on the target object, thereby improving efficiency of information processing.

The schematic diagram of the scenario to which the information processing method is applied shown in FIG. 1 is merely an example. The disclosure and scenario of the information processing method described in this embodiment of this disclosure are intended to describe the technical solution of this embodiment of this disclosure more clearly, and do not constitute a limitation on the technical solution provided in this embodiment of this disclosure. A person of ordinary skill in the art may learn that, with the evolution of application and the emergence of new service scenarios of the information processing method, the technical solution provided in this embodiment of this disclosure is also applicable to similar technical problems.

Detailed descriptions are separately provided below. A description sequence of the following embodiments is not intended to limit a preference sequence of the embodiments.

In this embodiment, descriptions are provided from the perspective of an information processing apparatus. The information processing apparatus may specifically be integrated into a computer device such as a terminal or a server.

Referring to FIG. 2, FIG. 2 is a schematic flowchart of an information processing method according to an embodiment of this disclosure. The information processing method may include the following operations:

S101: Acquire target limb information, and acquire user identification information corresponding to the target limb information. In an example, target limb information and user identification information are acquired.

The target limb information and an acquisition manner thereof may be flexibly set according to an actual requirement, which are not limited herein. For example, the target limb information may identify an action or a pose made by using a limb of a user, for example, related limb information such as an eyeball action, a gesture, a posture, or a foot gesture. The acquisition manner of the target limb information may be collecting, in real time by using a limb collection device, the target limb information entered by the user, or receiving the target limb information transmitted by a server or another device. The acquisition manner in this step, for example, the collection manner or the receiving manner mentioned above, may be a non-contact acquisition manner. The non-contact acquisition manner means that when a computer device acquires the target limb information of the user, the user does not need to be in contact with the computer device. For example, the user does not need to perform a touch operation on the computer device. The non-contact acquisition manner may include, for example, a video collection manner and a data transmission manner, which is not limited in this disclosure.

In an implementation, the obtaining target limb information may include: acquiring an activation instruction, and activating a limb collection device in response to the activation instruction; collecting a plurality of frames of candidate limb images by using the limb collection device; and performing limb recognition on the plurality of frames of candidate limb images, to obtain the target limb information.

The limb collection device may be the foregoing computer device, or may be a device that can be controlled by the computer device. The limb collection device may be a device provided with a video collection component such as a camera or a camera lens (which may be a 3D camera lens). A limb image of the user may be collected by using the camera or the camera lens, to recognize limb information based on the limb image. To reduce power consumption of the limb collection device, a sleep mode may be entered when the limb image does not need to be collected, and the limb image may be activated and collected when the limb image needs to be collected. Specifically, whether the activation instruction is acquired may be detected in real time or according to a preset time period. If the activation instruction is acquired, the limb collection device is activated in response to the activation instruction. The preset time period may be flexibly set according to an actual requirement, and a type and a generation manner of the activation instruction may be flexibly set according to an actual requirement, which are not limited herein.

The limb collection device is deactivated (for example, in a sleep mode or a power saving mode) in a non-operating time period, and the limb collection device is activated by using the activation instruction when the target limb information needs to be acquired, which can effectively reduce power consumption of the device and prevent unnecessary or wrong acquisition behaviors when the target limb information does not need to be acquired, thereby improving efficiency and precision of acquisition.

In an implementation, the acquiring an activation instruction may include: detecting distance information between a living body and the limb collection device, and generating the activation instruction when the distance information is less than a preset distance threshold; or generating the activation instruction when a face image or a target gesture is detected.

For example, whether a living body approaches the limb collection device may be detected. The living body may be a user. When a living body approaches the limb collection device, distance information between the living body and the limb collection device may be detected by using a ranging sensor such as an infrared ray or an ultrasonic wave. Then, whether the distance information between the living body and the limb collection device is less than the preset distance threshold is determined. The preset distance threshold may be flexibly set according to an actual requirement, which is not limited herein. When the distance information between the living body and the limb collection device is less than the preset distance threshold, a user approaches the limb collection device. In this case, the activation instruction may be generated. When the distance information between the living body and the limb collection device is greater than or equal to the preset distance threshold, no user approaches the limb collection device. In this case, the activation instruction may not be generated. The activation instruction configured for activating the limb collection device is generated by detecting that a user approaches, which can improve convenience of activation of the limb collection device.

In another example, whether a face image is collected may be detected by using a camera, a camera lens, or the like. If the face image is detected, the user may need to use the limb collection device. In this case, the activation instruction may be generated. The activation instruction is not generated if the face image is not detected. Alternatively, whether a target gesture is collected may be detected by using a camera, a camera lens, or the like. The target gesture may be a gesture configured for activating the limb collection device. The target gesture may be flexibly set according to an actual requirement. For example, the target gesture may be an OK gesture, a hand waving gesture, or the like. If the target gesture is detected, the user needs to use the limb collection device. In this case, the activation instruction may be generated. If the target gesture is not detected, the activation instruction may not be generated. Alternatively, when it is detected by using a proximity sensor (PSensor) that the user approaches, the target gesture may be collected. When the target gesture matches an activation gesture, the activation instruction is generated. The activation gesture may be flexibly set according to an actual requirement, which is not limited herein.

Then, the limb collection device may be activated in response to the activation instruction, and a plurality of frames of candidate limb images are collected by using the limb collection device. The candidate limb images may include images of limb information. In this case, limb recognition may be respectively performed on the plurality of frames of candidate limb images by using a trained image recognition model, to obtain candidate limb information corresponding to each frame of candidate limb image, and fusion analysis is performed on the plurality of pieces of candidate limb information, to obtain the target limb information. The image recognition model may be flexibly set according to an actual requirement. For example, the image recognition model may include a trained image recognition model such as a target detection algorithm YOLOS, a faster convolutional neural network (RCNN), a target detection algorithm (Single Shot MultiBox Detector, SSD), a lightweight visual recognition network ShuffleNet or MobileNetV2, or a human pose estimation algorithm DeepPose, and may further include a machine learning algorithm such as a support vector machine or a random forest. Alternatively, the plurality of frames of candidate limb images may be filtered to obtain a candidate limb image whose quality satisfies a condition, and limb recognition is performed on the selected one or more frames of candidate limb images, to obtain the target limb information. For example, an image parameter of each frame of candidate limb image may be acquired, quality assessment is separately performed on each frame of candidate limb image based on the image parameter of each frame of candidate limb image, and a candidate limb image with better quality is selected. The image parameter may include image contrast, image brightness saturation, image brightness, image exposure, image resolution, and the like.

In an implementation, the acquiring user identification information corresponding to the target limb information may include: extracting feature data of the target limb information, and determining the user identification information corresponding to the target limb information according to the feature data; or acquiring user indication information indicating inputting the target limb information, and determining the user identification information corresponding to the target limb information according to the user indication information.

The user identification information may be a user identity document (ID) configured for uniquely identifying a user. To improve convenience and flexibility of acquisition of the user identification information, after the target limb information is obtained, feature data of the target limb information may be extracted. The feature data may include a length, a width, a shape, and the like of a limb. Since different users correspond to different feature data such as lengths, widths, shapes of limbs, the user identification information corresponding to the target limb information may be determined according to the feature data. For example, a pre-stored correspondence between feature data and user identification information may be acquired from a database, and the user identification information corresponding to the feature data of the target limb information is queried for based on the correspondence, thereby obtaining the user identification information corresponding to the target limb information.

To improve accuracy of acquisition of the user identification information, the user indication information indicating inputting the target limb information may be acquired. The user indication information may include instant messaging ID, human face information, palm information (including palmprint information, a palm vein feature, and the like), and the like used by the user. Then, the user identification information corresponding to the target limb information may be determined according to the user indication information. For example, a pre-stored correspondence between user indication information and user identification information may be acquired from the database, and the user identification information corresponding to the user indication information is queried for based on the correspondence between the user indication information and the user identification information.

By providing manners of recognizing user identification information in different dimensions, flexible selection may be performed based on different acquisition scenarios and different acquisition requirements, thereby effectively improving an application range of this embodiment of this disclosure.

S102: Acquire custom limb configuration information matching the user identification information. In an example, customized limb configuration information that matches the user identification information is acquired.

The custom limb configuration information may include custom limb information set by the user according to a requirement of the user, and include a correspondence between user identification information and biological information (e.g., palm information). Custom limb configuration information corresponding to different users may be different.

In an implementation, before the acquire custom limb configuration information matching the user identification information, the information processing method may further include: receiving a configuration instruction, and entering a configuration mode in response to the configuration instruction; receiving, in the configuration mode, inputted custom limb information, and acquiring the user identification information corresponding to the custom limb information; and generating the custom limb configuration information according to the user identification information and the custom limb information.

For convenience and efficiency of acquisition of the custom limb configuration information, the user may preset and store custom limb configuration information of the user, so as to quickly acquire the custom limb configuration information when needing to use the custom limb configuration information. For example, the configuration instruction may be received. The configuration instruction may be generated based on a collected configuration gesture (which may be flexibly set), or may be generated based on an inputted related voice such as “custom limb configuration information”, or may be generated by triggering a display screen or a key. Then, the configuration mode may be entered in response to the configuration instruction, a configuration interface may be displayed in the configuration mode, and a style, a display manner, and the like of the configuration interface may be flexibly set according to an actual requirement, which are not limited herein. In the configuration mode, limb information (e.g., a gesture and an instruction corresponding to the gesture) entered by the user may be collected by using a camera lens, a camera, or the like of a computer device, user identification information corresponding to the limb information is acquired, and custom limb configuration information is generated according to the user identification information and the limb information.

Palm information, a voiceprint, human face information, and the like of the user that correspond to the user identification information may be further acquired according to an actual requirement, and the custom limb configuration information is generated based on a correspondence among the user identification information, the limb information, the palm information, the voiceprint, the human face information, and the like. For example, the limb information is a gesture, and a user A may set that custom limb configuration information of the user A includes: a correspondence among a user ID, a gesture a1, an instruction 1 corresponding to the gesture a1, a gesture a2, an instruction 2 corresponding to the gesture a2, a gesture a3, an instruction 3 corresponding to the gesture a3, palm information A, and the like. A user B may set that custom limb configuration information of the user B includes: a correspondence among a user ID, a gesture b1, feature data of the gesture b1, an instruction 1 corresponding to the gesture b1, a gesture b2, feature data of the gesture b2, an instruction 2 corresponding to the gesture b2,palm information B, face information B, and the like.

After the custom limb configuration information is obtained, the custom limb configuration information may be stored in a local device or a remote server. To improve security of storage of the custom limb configuration information, the custom limb configuration information may be encrypted by using an encryption algorithm, to obtain encrypted custom limb configuration information, and the encrypted custom limb configuration information is stored in a light database SQLite of the local device, or stored in the server.

By providing the user with a custom entry of the limb information, the user may enter the custom limb information by using the configuration instruction at an appropriate occasion, and may update the custom limb information at any time, thereby improving configuration efficiency.

After the user identification information corresponding to the target limb information is acquired, the custom limb configuration information matching the user identification information may be acquired. In an implementation, the acquiring custom limb configuration information matching the user identification information may include: querying whether the custom limb configuration information matching the user identification information is stored in a local device; acquiring the custom limb configuration information corresponding to the target limb information from the local device if the custom limb configuration information matching the user identification information is stored in the local device; and acquiring the custom limb configuration information corresponding to the target limb information from a server if the custom limb configuration information matching the user identification information is not stored in the local device.

Since the custom limb configuration information may be stored in the local device or stored in the server, the local device may be queried first. If the custom limb configuration information matching the user identification information is stored in the local device, the custom limb configuration information corresponding to the target limb information may be quickly acquired from the local device. If the custom limb configuration information matching the user identification information is not stored in the local device, an information acquisition request may be transmitted to the server, and the custom limb configuration information corresponding to the target limb information and returned by the server is received based on the information acquisition request, improving flexibility of acquisition of the custom limb configuration information.

S103: Match the target limb information with limb information included in the custom limb configuration information, to obtain limb information matching the target limb information. In an example, the target limb information is matched with reference limb information in the customized limb configuration information.

For example, a similarity between the target limb information and the limb information may be calculated, and when the similarity is greater than a preset similarity threshold, it is determined that the target limb information matches the limb information. Alternatively, matching may be performed by using a template matching method. That is, an action of the target limb information (e.g., a gesture) is considered as a sequence including static limb images, and then a target limb information template sequence (e.g., a to-be-recognized gesture template sequence) is compared with a limb information template sequence (e.g., a known gesture template sequence), so as to acquire the limb information matching the target limb information.

In an implementation, the matching the target limb information with limb information included in the custom limb configuration information, to obtain limb information matching the target limb information may include: comparing target gesture feature information included in the target limb information with gesture feature information of the limb information included in the custom limb configuration information, to acquire a similarity between the target gesture feature information and the gesture feature information; and determining limb information corresponding to the gesture feature information of which the similarity is greater than a preset similarity threshold to be the limb information matching the target limb information.

The limb information may include a gesture, and gesture feature information of the gesture may include a size, a shape, and the like of the gesture. To improve reliability of gesture registration, the target gesture feature information included in the target limb information may be extracted, and the gesture feature information of the limb information included in the custom limb configuration information may be extracted. The target gesture feature information included in the target limb information is compared with the gesture feature information of the limb information included in the custom limb configuration information, to acquire the similarity between the target gesture feature information and the gesture feature information. Then, it is determined whether the similarity between the target gesture feature information and the gesture feature information is greater than a preset similarity threshold, and if the similarity between the target gesture feature information and the gesture feature information is greater than the preset similarity threshold, limb information corresponding to the gesture feature information of which the similarity is greater than the preset similarity threshold is determined to be the limb information matching the target limb information. If the similarity between the target gesture feature information and the gesture feature information is less than or equal to the preset similarity threshold, the limb information does not match the target limb information.

Since the gesture information has a stronger expressive capability and easily forms a particular hand posture, a more accurate matching result may be obtained by using the gesture feature information in the limb information as a matching basis. In addition, since only gesture information may be required for matching, matching efficiency can be effectively improved.

S104: Select a target object according to the limb information matching the target limb information. In an example, a target object is selected according to the reference limb information.

The target object is a virtual or physical object provided by the computer device for display by using a display screen, and may be flexibly set according to an actual requirement, which is not limited herein. For example, for an application scenario of item purchase, the target object may be a selected item. In another example, for an application scenario of video playback, the target object may be a selected video. In another example, for an application scenario of text copy, the target object may be selected text.

In an implementation, the limb information may include a first limb action, a second limb action, and the like, and the selecting a target object according to the limb information matching the target limb information may include: displaying an information selection interface in response to the first limb action matching the target limb information; and selecting the target object in the information selection interface in response to the second limb action.

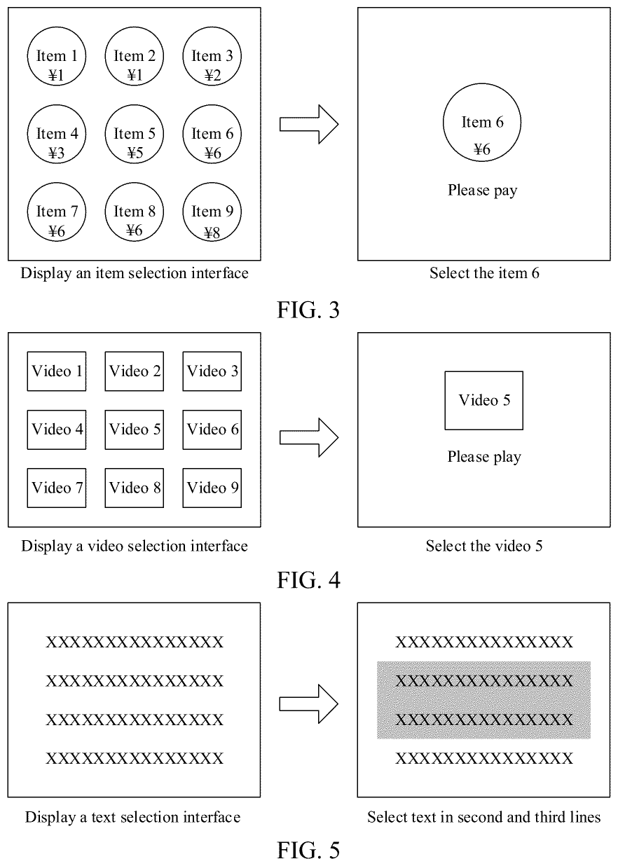

Limb actions may include various actions made by the user by using limbs, for example, a gesture, an eye action, a facial action, and a head action. The first limb action and the second limb action belong to different limb actions, and the first limb action and the second limb action may be flexibly set according to an actual requirement, which are not limited herein. For example, when the first limb action and the second limb action are respectively a first gesture and a second gesture, the first gesture may be a gesture of any number from 1 to 8, or another gesture, and the second gesture may be a heart-shaped gesture, an OK gesture, or the like. To improve convenience and flexibility of selection of the target object, the target object may be selected by using a gesture. For example, as shown in FIG. 3, for an application scenario of item purchase, an item selection interface may be displayed in response to the first gesture matching the target limb information, and then an item 6 is selected in the item selection interface in response to the second gesture. In another example, as shown in FIG. 4, for an application scenario of video playback, a video selection interface may be displayed in response to the first gesture matching the target limb information, and then a video 5 is selected in the video selection interface in response to the second gesture. In another example, as shown in FIG. 5, for an application scenario of text copy, a text selection interface may be displayed in response to the first gesture matching the target limb information, and then text in second and third lines is selected in the text selection interface in response to the second gesture.

Different information processing functions are implemented in response to different limb actions, so that the user can perform information processing more conveniently by using the limb actions, thereby effectively improving efficiency of non-contact information processing.

In an implementation, the selecting the target object in the information selection interface in response to the second limb action may include: performing a moving or zooming operation on the information selection interface in response to the second limb action, to obtain an updated information selection interface; and selecting the target object in the updated information selection interface.

To facilitate the selection of the target object, an operation such as moving, zooming out, or zooming in may be performed on the information selection interface, so that the user can browse and select the target object according to a requirement of the user. For example, the information selection interface may be moved left, right, up, or down in response to the second gesture, to obtain the updated information selection interface, and then the target object may be selected in the updated information selection interface. In another example, the information selection interface may be zoomed out or zoomed in in response to the second gesture, to obtain the updated information selection interface, and then the target object may be selected in the updated information selection interface.

When there are more objects involved in the information selection interface, the information selection interface may be displayed in response to the second limb action, thereby facilitating the user to select a desired target object and improving efficiency of selection of the target object.

S105: Acquire biological information matching the user identification information, and perform a corresponding operation on the target object based on the biological information. In an example, biometric information that matches the user identification information is acquired and an operation is performed with the target object based on the biometric information.

For the user corresponding to the user identification information, the biological information may include various types of biological information that may identify an identity of the user, for example, a fingerprint, iris, voice, a face, and a palm, which is not limited in this disclosure.

In this step, the computer device may acquire the biological information in a non-contact manner, so that the user may not be required to perform a touch operation on the computer device throughout the information processing, thereby improving a hygiene level and processing efficiency.

When the biological information includes palm information, the palm information may include a position, a shape, a size, palmprint information, a palm vein feature, and the like of a palm. Next, a description is provided mainly by using an example in which the biological information is palm information.

The computer device may collect, by using a palm collection device (which may be a limb collection device) carrying a camera, a camera lens, or the like, palm information entered by the user and matching the user identification information. When the palm information entered by the user matches palm information corresponding to the pre-stored user identification information, based on the palm information, a corresponding payment operation may be performed on an item, or a corresponding playback operation may be performed on a video, or a corresponding copy operation may be performed on text, or the like. When the palm information entered by the user does not match the palm information corresponding to the pre-stored user identification information, a null operation may be performed on the target object.

The pre-stored palm information may correspond to one or more pieces of user identification information. For example, for a user, palm information of a left hand and a right hand corresponding to user identification information of the user may be stored. In another example, for a family, one piece of user identification information may be set, and then palm information corresponding to multiple users such as a family member A, a family member B, and a family member C is associatively stored based on the user identification information. In this way, when any family member enters the palm information, a corresponding operation may be performed on the target object based on the palm information.

In an implementation, the acquiring palm information matching the user identification information may include: acquiring a plurality of frames of palm images matching the user identification information; performing quality assessment on each frame of palm image, to obtain a quality assessment result corresponding to each frame of palm image; selecting a target palm image from the plurality of frames of palm images based on the quality assessment result corresponding to each frame of palm image; and performing palm recognition on the target palm image, to obtain the palm information.

To improve accuracy of acquisition of the palm information, a palm image with good quality can be selected from the plurality of frames of palm images, and palm recognition is performed based on the selected palm image, to obtain the palm information. Specifically, a plurality of frames of palm images entered by the user and matching the user identification information may be collected by using a palm collection device carrying a camera, a camera lens, an infrared sensor, or the like, and then quality assessment may be performed on each frame of palm image, to obtain a quality assessment result corresponding to each frame of palm image. A quality assessment manner may be flexibly set according to an actual requirement, which is not limited herein.

In an implementation, the performing quality assessment on each frame of palm image, to obtain a quality assessment result corresponding to each frame of palm image may include: acquiring palm feature information included in each frame of palm image, and acquiring an image parameter of each frame of palm image; and performing quality assessment on each frame of palm image according to the palm feature information and the image parameter, to obtain the quality assessment result corresponding to each frame of palm image.

For example, the palm feature information included in each frame of palm image may be acquired. The palm feature information may include a palm size, an angle, and the like. The palm may be a complete palm including fingers, or may be a palm not including fingers, which is not limited herein. Moreover, the image parameter of each frame of palm image may be acquired. The image parameter may include image contrast, image brightness saturation, image brightness, image exposure, image resolution, and the like. Then, quality assessment may be performed on each frame of palm image according to the palm feature information and the image parameter, to obtain the quality assessment result corresponding to each frame of palm image. For example, the palm feature information and the image parameter may be separately scored, and weights of the palm feature information and the image parameter are set. A weighting operation is performed based on the scores of the palm feature information and the image parameter, and the weights of the palm feature information and the image parameter, to obtain a quality assessment score. A larger quality assessment score indicates better quality of the palm image. Otherwise, a smaller quality assessment score indicates worse quality of the palm image, thereby improving reliability of quality assessment performed on the palm image.

In this case, a target palm image with better quality may be selected from the plurality of frames of palm images based on the quality assessment result corresponding to each frame of palm image. For example, a palm image whose quality assessment score is greater than a preset score threshold may be selected from the plurality of frames of palm images, to obtain the target palm image.

After the target palm image is obtained, palm recognition may be performed on the target palm image, to obtain the palm information. In an implementation, the performing palm recognition on the target palm image, to obtain the palm information may include: extracting palmprint information and a palm vein feature of a palm that are included in the target palm image; and generating palm information based on the palmprint information and the palm vein feature.

For example, the palmprint information and the palm vein feature of the palm that are included in the target palm image may be extracted by using an image recognition model, and the palmprint information and the palm vein feature are used as the palm information, or the palmprint information and the palm vein feature are optimized and then used as the palm information.

In an implementation, the acquiring palm information matching the user identification information may include: acquiring a color palm image and an infrared palm image that match the user identification information; fusing the color palm image and the infrared palm image, to obtain a fused palm image; and performing palm recognition according to the fused palm image, to obtain the palm information.

To improve accuracy of acquisition of the palm information, the palm information may be acquired in a multi-image fusion manner. Specifically, the color palm image of the palm entered by the user and matching the user identification information may be collected by using a camera, a camera lens, or the like, and the infrared palm image of the palm entered by the user and matching the user identification information may be collected by using an infrared camera. Then, the color palm image and the infrared palm image may be fused by using a fusion algorithm RGB-NIR or another fusion algorithm, to obtain the fused palm image. In this case, palm recognition may be performed based on the fused palm image, to obtain palm information. For example, palmprint information, a palm vein feature, and the like of a palm that are included in the fused palm image may be extracted, and the palm information is generated based on the palmprint information, the palm vein feature, and the like.

In an implementation, the performing a corresponding operation on the target object based on the biological information may include: acquiring payment information corresponding to the target object based on the biological information; and performing a payment operation based on the payment information.

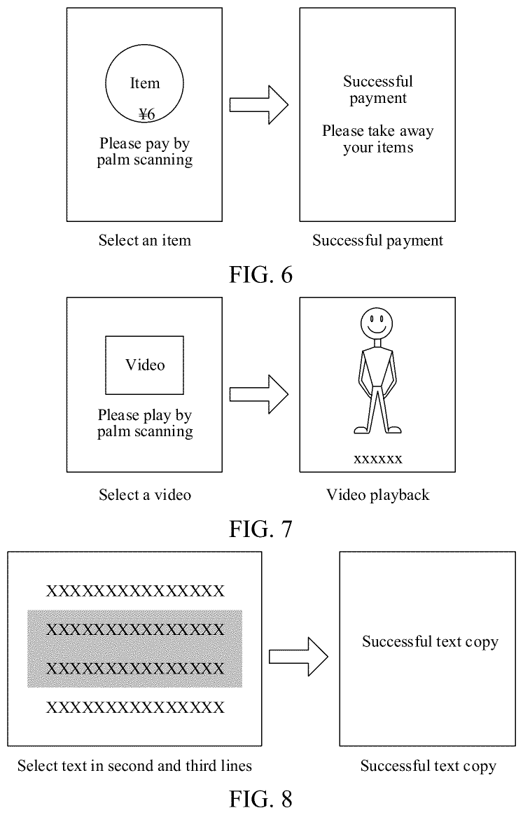

For example, as shown in FIG. 6, for an application scenario of item purchase, payment information corresponding to a selected item may be acquired in response to the palm information. The payment information may include related information such as a payment amount and a payment account associated with the user identification information corresponding to the palm information. Then, a payment operation may be performed based on the payment information, and the item may be taken away after successful payment.

In an implementation, the performing a corresponding operation on the target object based on the biological information may include: acquiring link information corresponding to the target object based on the biological information; and acquiring a playback file of the target object based on the link information, and playing back the playback file.

For example, as shown in FIG. 7, for an application scenario of video playback, link information corresponding to a selected video may be acquired in response to the palm information. The link information may include a storage address or other information corresponding to a playback file of the video. The playback file of the video may be acquired based on the link information, and the video is played back based on the playback file.

In an implementation, the performing a corresponding operation on the target object based on the biological information may include: generating a copy instruction based on the biological information, and performing a copy operation on the target object in response to the copy instruction.

For example, as shown in FIG. 8, for an application scenario of text copy, a copy instruction may be generated in response to the palm information, a copy operation is performed on selected text in response to the copy instruction, and prompt information related to successful copy is displayed, so as to copy the text to a desired position.

After the target object is selected, the computer device may further perform different information processing based on the biological information according to different types of the target object, so that the embodiments of this disclosure have a relatively wide application range, thereby improving an information processing range.

According to the embodiments of this disclosure, the inputted target limb information may be acquired, the user identification information corresponding to the target limb information may be acquired, and the custom limb configuration information matching the user identification information may be acquired. Then, the target limb information may be matched with the limb information included in the custom limb configuration information, to obtain the limb information matching the target limb information. The target object may be selected according to the limb information matching the target limb information. In this case, the palm information matching the user identification information may be acquired, and a corresponding operation is performed on the target object based on the palm information. In the solution, the target object is selected by using the limb information matching the target limb information in the custom limb configuration information matching the user identification information, and a corresponding operation is performed on the target object based on the palm information. The entire process does not require the user to perform a touch operation, which improves a hygiene level and improves efficiency of information processing.

In this disclosure, the biological information as referred to is, for example, human face information, palm information, or another biological feature recognition technology. When the foregoing embodiments of this disclosure are applied to a specific product or technology, a collection, use, and processing process of related data needs to comply with national legal and regulation requirements. Before human face information, palm information, or another biological feature is collected, an information processing rule needs to be notified, and individual agreement of a target object for any piece of biological information is solicited. The human face information, the palm information, or the another biological feature is processed strictly according to the legal and regulation requirements and a personal information processing rule, and technical measures are taken to ensure security of the related data.

According to the method described in the foregoing embodiments, the following further provides a detailed description by using an example.

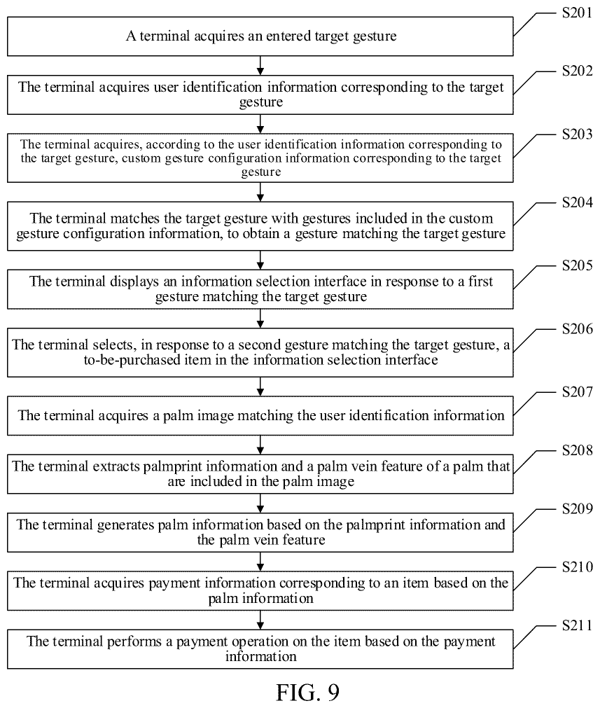

In this embodiment, for example, an information processing apparatus is integrated in a terminal, and limb information is a gesture. In an application scenario of item purchase, the terminal may purchase an item by using a gesture and palm information. Referring to FIG. 9, FIG. 9 is a schematic flowchart of an information processing method according to an embodiment of this disclosure. A procedure of the method may include the following operations:

S201: A terminal acquires an entered target gesture.

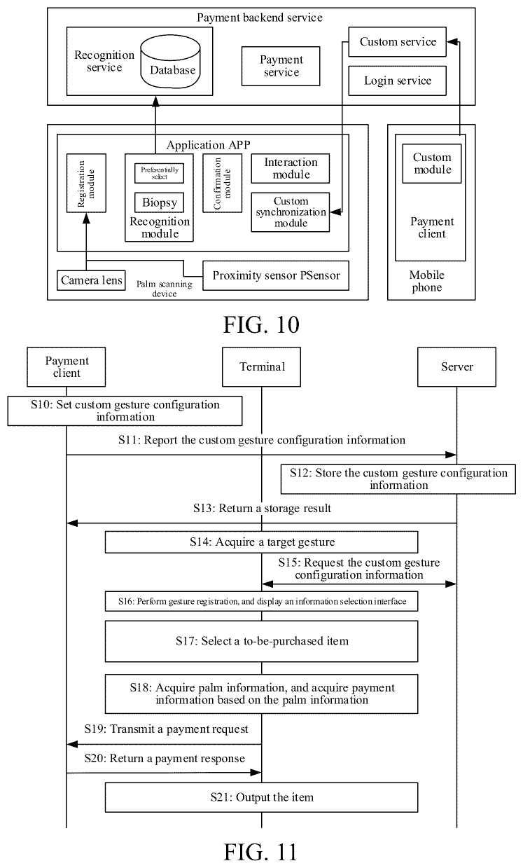

A plurality of target gestures may be included. For example, the target gesture may include a gesture A and a gesture B. As shown in FIG. 10, the terminal may be a palm scanning device. The palm scanning device may collect, by using a camera lens, a target gesture entered by a user, and may further interact with the user by using an interaction module. To improve accuracy of gesture recognition, after detecting, by using a proximity sensor, that an object approaches, the palm scanning device may perform living body detection (that is, biopsy) on the approaching object by using a recognition module, and preferentially select collected gesture images, so as to select a gesture image with better quality for gesture recognition, to obtain the target gesture.

S202: The terminal acquires user identification information corresponding to the target gesture.

The terminal may recognize user identification information of the user entering the target gesture.

S203: The terminal acquires, according to the user identification information corresponding to the target gesture, custom gesture configuration information corresponding to the target gesture.

For example, as shown in FIG. 10, the terminal may acquire, by using a custom synchronization module, the custom gesture configuration information corresponding to the target gesture from a server providing a payment backend service.

As shown in FIG. 10 and FIG. 11, the custom gesture configuration information may be set by using a custom module of a payment client. The payment client may be an instant messaging application APP installed on a mobile phone. In the payment client, an account may be logged in to based on a login service provided by a server. Then, the custom module of the payment client may receive custom gesture configuration information entered by the user, report the custom gesture configuration information to the server providing the payment backend service for storage, and may store the custom gesture configuration information into a database. After successfully storing the custom gesture configuration information, the server may return a storage result indicating successful storage to the payment client. The server may synchronize the custom gesture configuration information to the custom synchronization module of the terminal (that is, the palm scanning device) according to an actual requirement by using a custom service. When the custom gesture configuration information is required for gesture registration, the terminal may request, by using the custom synchronization module, a custom service of the server to acquire the custom gesture configuration information.

S204: The terminal matches the target gesture with gestures included in the custom gesture configuration information, to obtain a gesture matching the target gesture.

For example, as shown in FIG. 10, the terminal may match, by using a registration module, the target gesture with the gesture included in the custom gesture configuration information, to obtain the gesture matching the target gesture.

S205: The terminal displays an information selection interface in response to a first gesture matching the target gesture.

For example, as shown in FIG. 10 and FIG. 11, the terminal matches the target gesture with the gestures included in the custom gesture configuration information. If the gesture A included in the target gesture matches the first gesture included in the custom gesture configuration information, the terminal may display, in response to the first gesture, the information selection interface by using the interaction module.

S206: The terminal selects, in response to a second gesture matching the target gesture, a to-be-purchased item in the information selection interface.

For example, as shown in FIG. 11, the terminal matches the target gesture with the gestures included in the custom gesture configuration information. If the gesture B included in the target gesture matches the second gesture included in the custom gesture configuration information, the terminal may select, in response to the second gesture, the to-be-purchased item in the information selection interface.

S207: The terminal acquires a palm image matching the user identification information.

After the to-be-purchased item is selected, the user may be prompted, by using the interaction module, to perform palm scanning payment. For example, the terminal may collect, by using a camera lens, a palm image of the user matching the user identification information.

S208: The terminal extracts palmprint information and a palm vein feature of a palm that are included in the palm image.

For example, as shown in FIG. 10, to improve accuracy of palm recognition, living body detection (i.e., biopsy) may be performed on an approaching palm by using a recognition module, to determine that the palm is a palm of a living body, and collected palm images are preferentially selected, to select a palm image with better quality for palm recognition, so as to extract the palmprint information and the palm vein feature of the palm that are included in the palm image.

S209: The terminal generates palm information based on the palmprint information and the palm vein feature.

The terminal may take the palmprint information and the palm vein feature as the palm information.

S210: The terminal acquires payment information corresponding to an item based on the palm information.

For example, as shown in FIG. 10 and FIG. 11, the terminal may compare, by using a registration module, the palm information with palm information pre-stored in a database of a recognition service in the server, and if the acquired palm information matches the pre-stored palm information, the terminal may acquire the payment information corresponding to the item.

S211: The terminal performs a payment operation on the item based on the payment information.

For example, as shown in FIG. 10 and FIG. 11, the terminal may request, by using the payment client, a payment service of the server to perform a payment operation based on the payment information. After successful payment, the payment client may return a payment response, to indicate the successful payment. In this case, the terminal may output the item for the user to take away.

In the foregoing embodiments, the descriptions of the embodiments have different focuses, and for a part that is not described in detail in an embodiment, reference may be made to the detailed description of the information processing method above. Details are not described herein again.

In this embodiment, the target gesture and the user identification information corresponding thereto may be acquired, the target gesture is matched with gestures included in the custom gesture configuration information corresponding to the user identification information, the information selection interface is displayed based on a matched gesture, and a to-be-purchased item is selected in the information selection interface. Then, the palm information matching the user identification information and the payment information corresponding to the item are acquired, and a payment operation is performed on the item based on the payment information, so that the item is accurately selected by using the gesture. In addition, a corresponding operation is performed on the item based on the palm information. The entire process does not require the user to perform a touch operation, which improves a hygiene level and improves efficiency of information processing.

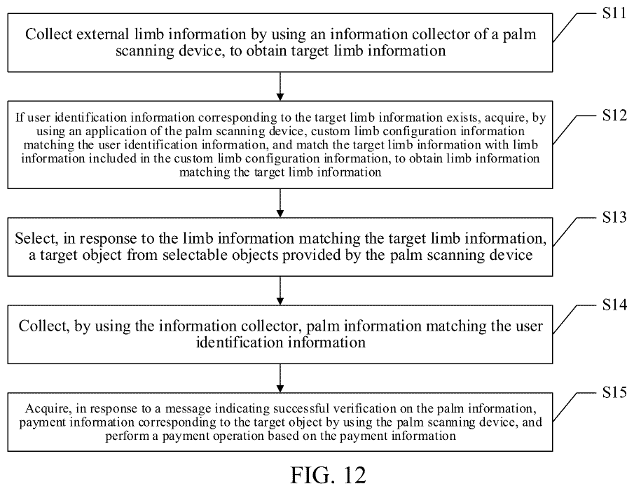

In this embodiment, the description is provided from the perspective of the palm scanning device. Referring to FIG. 12, FIG. 12 is a schematic flowchart of an information processing method based on a palm scanning device according to an embodiment of this disclosure. The palm scanning device may be the foregoing computer device, or may be another device having a data connection relationship with the computer device.

The information processing method may include the following operations:

S11: Collect external limb information by using an information collector of the palm scanning device, to obtain target limb information.

For example, as shown in FIG. 10, the palm scanning device may be provided with an information collector, an application, and the like. The information collector may include a camera lens, a proximity sensor, and the like. The palm scanning device may collect the external limb information by using the camera lens, to obtain the target limb information.

To reduce power consumption of the palm scanning device, when the limb information does not need to be acquired, the palm scanning device may be controlled to enter a sleep mode, and when the limb information needs to be acquired, the palm scanning device may be activated, so as to acquire the external limb information by using the information collector of the palm scanning device. Specifically, whether an activation instruction is acquired may be detected in real time or according to a preset time period. For example, when a living body approaches the palm scanning device, distance information between the living body and the palm scanning device may be detected by using a ranging sensor such as an infrared or an ultrasonic wave. Then, whether the distance information between the living body and the palm scanning device is less than a preset distance threshold is determined. The preset distance threshold may be flexibly set according to an actual requirement, which is not limited herein. When the distance information between the living body and the palm scanning device is less than the preset distance threshold, a user approaches the palm scanning device. In this case, the activation instruction may be generated. If it is not detected that the distance information between the living body and the palm scanning device is less than the preset distance threshold, the activation instruction is not generated. In another example, whether a face image or a target gesture is collected may be detected by using a camera, a camera lens, or the like. If the face image or the target gesture is detected, the user needs to use the palm scanning device. In this case, the activation instruction may be generated. If the face image or the target gesture is not detected, the activation instruction may not be generated. The palm scanning device is activated in response to the activation instruction if the activation instruction is acquired.

To improve accuracy of acquisition of the target limb information, the palm scanning device may preferentially select limb images collected by the camera lens, to select a limb image with better quality for limb recognition, to obtain the target limb information. For example, an image parameter of each frame of limb image may be acquired, quality assessment is separately performed on each frame of limb image based on the image parameter of each frame of limb image, and a limb image with better quality is selected. Limb recognition is performed on the selected limb image, to obtain the target limb information. The image parameter may include image contrast, image brightness saturation, image brightness, image exposure, image resolution, and the like.

S12: If user identification information corresponding to the target limb information exists, acquire, by using an application of the palm scanning device, custom limb configuration information matching the user identification information, and match the target limb information with limb information included in the custom limb configuration information, to obtain limb information matching the target limb information.

For example, as shown in FIG. 10, after the target limb information is obtained, the palm scanning device may invoke, by using an application, a registration module to register the target limb information, to determine whether the user identification information corresponding to the target limb information exists. If the user identification information corresponding to the target limb information does not exist, the procedure ends. If the user identification information corresponding to the target limb information exists, by using the application of the palm scanning device, a custom synchronization module is invoked, to acquire the custom limb configuration information matching the user identification information from the server providing the payment backend service, and the registration module is invoked to match the target limb information with the limb information included in the custom limb configuration information, to obtain the limb information matching the target limb information. For example, target gesture feature information included in the target limb information may be compared with gesture feature information of the limb information included in the custom limb configuration information, to acquire a similarity between the target gesture feature information and the gesture feature information, and limb information corresponding to the gesture feature information of which the similarity is greater than a preset similarity threshold is determined to be the limb information matching the target limb information.

The acquiring custom limb configuration information matching the user identification information may include: querying whether the custom limb configuration information matching the user identification information is stored in a local device of the palm scanning device, and acquiring the custom limb configuration information matching the user identification information from the local device if the custom limb configuration information matching the user identification information is stored in the local device; and acquiring the custom limb configuration information matching the user identification information from a server if the custom limb configuration information matching the user identification information is not stored in the local device.

S13: Select, in response to the limb information matching the target limb information, a target object from selectable objects provided by the palm scanning device.

The palm scanning device may select, in response to the limb information matching the target limb information, the target object from the selectable objects provided by the palm scanning device. The target object may be a selected item. In an implementation, the limb information includes a first limb action and a second limb action, and the selecting, in response to the limb information matching the target limb information, a target object from selectable objects provided by the palm scanning device may include: displaying, in response to the first limb action matching the target limb information, an information selection interface by using a display screen of the palm scanning device; and moving the information selection interface left, right, up, or down or zooming out, or zooming in the information selection interface in response to the second limb action, to obtain an updated information selection interface, for the user to view the selectable objects, and selecting, in the updated information selection interface, the target object from the selectable objects provided by the palm scanning device.

S14: Collect, by using the information collector, palm information matching the user identification information.

After the target object is selected, the palm scanning device may invoke, by using an application, an interaction module to prompt the user to perform a palm scanning payment. For example, the palm scanning device may collect, by using a camera lens, a palm image of the user matching the user identification information, extract palmprint information and a palm vein feature of a palm that are included in the palm image, and generate palm information according to the palmprint information and the palm vein feature.

To improve accuracy of acquisition of the palm information, a plurality of frames of palm images matching the user identification information may be acquired, and quality assessment is performed on each frame of palm image, to obtain a quality assessment result corresponding to each frame of palm image. For example, palm feature information included in each frame of palm image and an image parameter of each frame of palm image may be acquired, and quality assessment is performed on each frame of palm image according to the palm feature information and the image parameter, to obtain the quality assessment result corresponding to each frame of palm image. Then, a target palm image with better quality may be selected from the plurality of frames of palm images based on the quality assessment result corresponding to each frame of palm image, and palm recognition is performed on the target palm image, to obtain the palm information. Alternatively, a color palm image and an infrared palm image that match the user identification information may be acquired, the color palm image and the infrared palm image are fused, to obtain a fused palm image, and palm recognition is performed according to the fused palm image, to obtain the palm information.

S15: Acquire, in response to a message indicating successful verification on the palm information, payment information corresponding to the target object by using the palm scanning device, and perform a payment operation based on the payment information.

After the palm information is collected, the palm scanning device may verify the palm information. For example, the registration module may be invoked to compare the palm information with palm information pre-stored in a database of a recognition service in the server, and if the acquired palm information matches the pre-stored palm information, the verification is successful. If the verification is successful, the payment information corresponding to the target object may be acquired by using the palm scanning device in response to the message indicating successful verification on the palm information, and a payment operation is performed based on the payment information. If the verification is not passed, the payment operation is not performed.

In the foregoing embodiments, the descriptions of the embodiments have different focuses, and for a part that is not described in detail in an embodiment, reference may be made to the detailed description of the information processing method above. Details are not described herein again.

In this embodiment of this disclosure, the external limb information may be collected by using the information collector of the palm scanning device, to obtain the target limb information. If the user identification information corresponding to the target limb information exists, the custom limb configuration information matching the user identification information is acquired by using the application of the palm scanning device, and the target limb information is matched with the limb information included in the custom limb configuration information, to obtain the limb information matching the target limb information. Then, in response to the limb information matching the target limb information, the target object may be selected from the selectable objects provided by the palm scanning device, and the palm information matching the user identification information is collected by using the information collector. In this case, in response to the message indicating successful verification on the palm information, the payment information corresponding to the target object may be acquired by using the palm scanning device, and the payment operation is performed based on the payment information. In the solution, the target object is selected by using the limb information matching the target limb information in the custom limb configuration information matching the user identification information, and a corresponding payment operation is performed on the target object based on the palm information. The entire process does not require the user to perform a touch operation, which improves a hygiene level and improves efficiency of information processing.

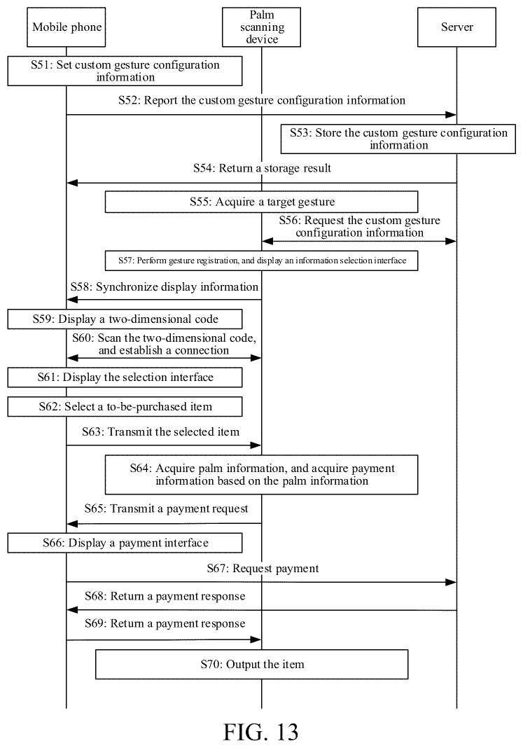

In this embodiment, the information processing method is illustrated by using interaction among the palm scanning device, the mobile phone, and the server. For example, the limb information is a gesture, and in an application scenario of item purchase, the palm scanning device may purchase an item by using the gesture and the palm information, may further establish a connection relationship with the mobile phone, and synchronize a display interface to the mobile phone for display, for the user to select a to-be-purchased item. Referring to FIG. 13, FIG. 13 is a schematic flowchart of an information processing method according to an embodiment of this disclosure. A procedure of the method may include the following operations:

S51: A mobile phone sets custom gesture configuration information.

S52: The mobile phone reports the custom gesture configuration information to a server.

S53: The server stores the custom gesture configuration information.

S54: The server returns a storage result to the mobile phone.

After successfully storing the custom gesture configuration information, the server may return a storage result indicating successful storage to the mobile phone.

S55: A palm scanning device acquires a target gesture.

The palm scanning device may collect, by using a camera lens, gestures entered by the user, to obtain the target gesture. To improve accuracy of gesture recognition, after detecting that an object approaches by using a proximity sensor, the palm scanning device may perform living body detection (that is, biopsy) on the approaching object by using a recognition module, and preferentially select collected gesture images, so as to select a gesture image with better quality for gesture recognition, to obtain the target gesture.

S56. The palm scanning device requests the server to acquire the custom gesture configuration information.

The palm scanning device may acquire user identification information corresponding to the target gesture, transmit an information acquisition request carrying the user identification information to the server, and receive custom gesture configuration information corresponding to the user identification information and returned by the server based on the information acquisition request.

S57: The palm scanning device registers the target gesture with a gesture included in the custom gesture configuration information, and if the target gesture matches the gesture included in the custom gesture configuration information, displays a selection interface; and if the target gesture does not match the gesture included in the custom gesture configuration information, skips displaying the selection interface.

S58. The palm scanning device synchronizes display information to the mobile phone.

The display information may include display information related to the selection interface, connection information required to establish a connection, and the like.

S59: The mobile phone displays a two-dimensional code based on the display information.

After receiving the display information, the mobile phone may display, in a display interface, a two-dimensional code or another graphic code configured for establishing a connection.

S60: The mobile phone scans the two-dimensional code, so as to establish a connection with the palm scanning device.

The mobile phone scans the two-dimensional code to acquire connection information, and then may establish a connection with the palm scanning device based on the connection information. The connection may be a Bluetooth connection, a near field communication (NFC) connection, or the like.

S61: The mobile phone displays the selection interface.

After establishing a connection with the palm scanning device, the mobile phone may communicate with the palm scanning device. For example, the palm scanning device may synchronize the selection interface and dynamically updated information thereof to the mobile phone, and the mobile phone may display the selection interface and synchronize the selection interface and the dynamically updated information thereof to the palm scanning device.

S62: The mobile phone selects a to-be-purchased item.

The mobile phone may perform an operation such as moving, zooming out, or zooming in on the selection interface in response to a selection gesture, a touch instruction, a slide instruction, or the like entered by the user, and select the to-be-purchased item on the selection interface. In this case, the mobile phone synchronizes the operation such as moving, zooming out, or zooming in on the selection interface to the palm scanning device, so that the palm scanning device synchronously displays the operation.

The user may select the to-be-purchased item on the mobile phone according to an actual requirement, or select the to-be-purchased item on the palm scanning device.

S63: The mobile phone transmits related information of the selected to-be-purchased item to the palm scanning device.

S64: The palm scanning device acquires palm information, and acquires payment information of the item based on the palm information.

For example, the palm scanning device may acquire a palm image matching the user identification information, extract palmprint information and a palm vein feature of a palm that are included in the palm image, and generate the palm information according to the palmprint information and the palm vein feature.

The palm scanning device may compare the palm information with palm information pre-stored in the server, and if the acquired palm information matches the pre-stored palm information, acquire the payment information corresponding to the item.

S65: The palm scanning device transmits a payment request to the mobile phone.

The palm scanning device may transmit the payment request to the mobile phone based on the payment information of the item.

S66: The mobile phone displays a payment interface based on the payment request.

S67: The mobile phone requests payment from the server.

The mobile phone may transmit the payment request to the server in response to a payment confirmation instruction entered by the user based on the payment interface.

S68: The server returns a payment response to the mobile phone.

After completing payment based on the payment request, the server may return the payment response to the mobile phone, to indicate successful payment.

S69: The mobile phone returns a payment response to the palm scanning device.

S70: The palm scanning device outputs the item.

After the successful payment, the palm scanning device may output the item for the user to take away.

In this embodiment, a connection may be established between the palm scanning device and the mobile phone, and information may be synchronized between the palm scanning device and the mobile phone, so that the user may choose to operate the palm scanning device or the mobile phone to purchase an item, thereby improving efficiency and convenience of item purchase.

In the foregoing embodiments, the descriptions of the embodiments have different focuses, and for a part that is not described in detail in an embodiment, reference may be made to the detailed description of the information processing method above. Details are not described herein again.

To better implement the information processing method provided in the embodiments of this disclosure, an embodiment of this disclosure further provides an apparatus based on the foregoing information processing method. Nouns have meanings the same as those in the foregoing information processing method. For specific implementation details, refer to the descriptions in the method embodiments.

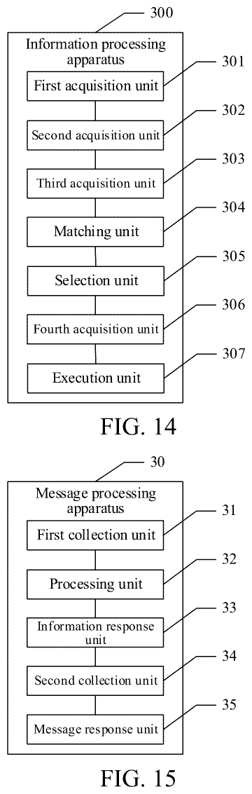

Referring to FIG. 14, FIG. 14 is a schematic structural diagram of an information processing apparatus according to an embodiment of this disclosure. The information processing apparatus 300 may include a first acquisition unit 301, a second acquisition unit 302, a third acquisition unit 303, a matching unit 304, a selection unit 305, a fourth acquisition unit 306, an execution unit 307, and the like.

The first acquisition unit 301 is configured to acquire target limb information.

The second acquisition unit 302 is configured to acquire user identification information corresponding to the target limb information.

The third acquisition unit 303 is configured to acquire custom limb configuration information matching the user identification information.

The matching unit 304 is configured to match the target limb information with limb information included in the custom limb configuration information, to obtain limb information matching the target limb information.

The selection unit 305 is configured to select a target object according to the limb information matching the target limb information.

The fourth acquisition unit 306 is configured to acquire biological information matching the user identification information.

The execution unit 307 is configured to perform a corresponding operation on the target object based on the biological information.

In an implementation, the selection unit 305 may include:

a display module configured to display an information selection interface in response to a first limb action matching the target limb information; and

a selection module configured to select the target object in the information selection interface in response to a second limb action.

In an implementation, the selection module may specifically be configured to: perform a moving or zooming operation on the information selection interface in response to the second limb action, to obtain an updated information selection interface; and select the target object in the updated information selection interface.

In an implementation, the biological information includes palm information, and the fourth acquisition unit 306 may include:

a first acquisition module configured to acquire a color palm image and an infrared palm image that match the user identification information;

a fusion module configured to fuse the color palm image and the infrared palm image, to obtain a fused palm image; and

a first recognition module configured to perform palm recognition according to the fused palm image, to obtain the palm information.

In an implementation, the first recognition module may specifically be configured to: extract palmprint information and a palm vein feature of a palm that are included in the target palm image; and generate palm information based on the palmprint information and the palm vein feature.

In an implementation, the fourth acquisition unit 306 may include:

a second acquisition module configured to acquire a plurality of frames of palm images matching the user identification information;

an assessment module configured to perform quality assessment on each frame of palm image, to obtain a quality assessment result corresponding to each frame of palm image; and

a filtering module configured to select a target palm image from the plurality of frames of palm images based on the quality assessment result corresponding to each frame of palm image; and

a second recognition module configured to perform palm recognition on the target palm image, to obtain the palm information.

In an implementation, the assessment module may specifically be configured to: acquire palm feature information included in each frame of palm image, and acquire an image parameter of each frame of palm image; and perform quality assessment on each frame of palm image according to the palm feature information and the image parameter, to obtain the quality assessment result corresponding to each frame of palm image.

In an implementation, the second recognition module may specifically be configured to: extract palmprint information and a palm vein feature of a palm that are included in the target palm image; and generate palm information based on the palmprint information and the palm vein feature.

In an implementation, the first acquisition unit 301 may include:

a third acquisition module configured to acquire an activation instruction, and activate a limb collection device in response to the activation instruction;

a collection module configured to collect a plurality of frames of candidate limb images by using the limb collection device; and

a third recognition module configured to perform limb recognition on the plurality of frames of candidate limb images, to obtain the target limb information.

In an implementation, the third acquisition module may specifically be configured to: detect distance information between a living body and the limb collection device, and generate the activation instruction when the distance information is less than a preset distance threshold; or generate the activation instruction when a face image or a target gesture is detected.

In an implementation, the second acquisition module 302 may specifically be configured to: extract feature data of the target limb information, and determine the user identification information corresponding to the target limb information according to the feature data; or acquire user indication information indicating inputting the target limb information, and determine the user identification information corresponding to the target limb information according to the user indication information.

In an implementation, the third acquisition module 303 may specifically be configured to: query whether the custom limb configuration information matching the user identification information is stored in a local device; acquire the custom limb configuration information corresponding to the target limb information from the local device if the custom limb configuration information matching the user identification information is stored in the local device; and acquire the custom limb configuration information corresponding to the target limb information from a server if the custom limb configuration information matching the user identification information is not stored in the local device.

In an implementation, the information processing apparatus 300 further includes:

a response unit configured to receive a configuration instruction, and enter a configuration mode in response to the configuration instruction;

a receiving unit configured to receive, in the configuration mode, inputted custom limb information, and acquire the user identification information corresponding to the custom limb information; and

a generation unit configured to generate the custom limb configuration information according to the user identification information and the custom limb information.

In an implementation, the matching module 304 may specifically be configured to: compare target gesture feature information included in the target limb information with gesture feature information of the limb information included in the custom limb configuration information, to acquire a similarity between the target gesture feature information and the gesture feature information; and determine limb information corresponding to the gesture feature information of which the similarity is greater than a preset similarity threshold to be the limb information matching the target limb information.

In an implementation, the execution unit 307 may specifically be configured to: acquire payment information corresponding to the target object based on the biological information; and perform a payment operation on the target object based on the payment information.

In an implementation, the execution unit 307 may specifically be configured to: acquire link information corresponding to the target object based on the biological information; and acquire a playback file of the target object based on the link information, and play back the playback file.

In an implementation, the execution unit 307 may specifically be configured to: generate a copy instruction based on the biological information, and perform a copy operation on the target object in response to the copy instruction.

According to this embodiment of this disclosure, the first acquisition unit 301 may acquire the inputted target limb information, the second acquisition unit 302 acquires the user identification information corresponding to the target limb information, and the third acquisition unit 303 acquires the custom limb configuration information matching the user identification information. Then, the matching unit 304 may match the target limb information with the limb information included in the custom limb configuration information, to obtain the limb information matching the target limb information. The selection unit 305 may select the target object according to the limb information matching the target limb information. In this case, the fourth acquisition unit 306 may acquire the palm information matching the user identification information, and the execution unit 307 performs a corresponding operation on the target object based on the palm information. In the solution, the target object is selected by using the limb information matching the target limb information in the custom limb configuration information matching the user identification information, and a corresponding operation is performed on the target object based on the palm information. The entire process does not require a user to perform a touch operation, which improves a hygiene level and improves efficiency of information processing.

To better implement the information processing method provided in the embodiments of this disclosure, an embodiment of this disclosure further provides an apparatus based on the foregoing information processing method. Nouns have meanings the same as those in the foregoing information processing method. For specific implementation details, refer to the descriptions in the method embodiments.

Referring to FIG. 15, FIG. 15 is a schematic structural diagram of an information processing apparatus according to an embodiment of this disclosure. The information processing apparatus 30 may include a first collection unit 31, a processing unit 32, an information response unit 33, a second collection unit 34, a message response unit 35, and the like.

The first collection unit 31 is configured to collect external limb information by using an information collector of a palm scanning device, to obtain target limb information.

The processing unit 32 is configured to, if user identification information corresponding to the target limb information exists, acquire, by using an application of the palm scanning device, custom limb configuration information matching the user identification information, and match the target limb information with limb information included in the custom limb configuration information, to obtain limb information matching the target limb information.

The information response unit 33 is configured to select, in response to the limb information matching the target limb information, a target object from selectable objects provided by the palm scanning device.

The second collection unit 34 is configured to collect, by using the information collector, palm information matching the user identification information.

The message response unit 35 is configured to acquire, in response to a message indicating successful verification on the palm information, payment information corresponding to the target object by using the palm scanning device, and perform a payment operation based on the payment information.

In an implementation, the limb information includes a first limb action and a second limb action, and the information response unit 33 is specifically configured to: display, in response to the first limb action matching the target limb information, an information selection interface by using a display screen of the palm scanning device; and perform a moving or zooming operation on the information selection interface in response to the second limb action, to obtain an updated information selection interface, and select, in the updated information selection interface, the target object from the selectable objects provided by the palm scanning device.

In this embodiment of this disclosure, the first collection unit 31 may collect the external limb information may be collected by using the information collector of the palm scanning device, to obtain the target limb information. The processing unit 32 acquires, by using the application of the palm scanning device, the custom limb configuration information matching the user identification information if the user identification information corresponding to the target limb information exists, and matches the target limb information with the limb information included in the custom limb configuration information, to obtain the limb information matching the target limb information. The information response unit 33 selects, in response to the limb information matching the target limb information, the target object from the selectable objects provided by the palm scanning device. The second collection unit 34 collects, by using the information collector, the palm information matching the user identification information. The message response unit 35 acquires, in response to a message indicating successful verification on the palm information, payment information corresponding to the target object by using the palm scanning device, and performs a payment operation based on the payment information. In the solution, the target object is selected by using the limb information matching the target limb information in the custom limb configuration information matching the user identification information, and a corresponding payment operation is performed on the target object based on the palm information. The entire process does not require the user to perform a touch operation, which improves a hygiene level and improves efficiency of information processing.

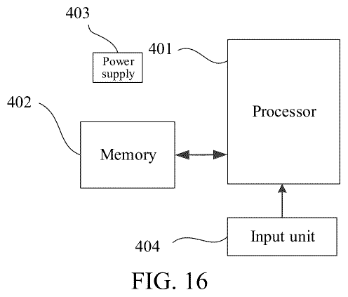

An embodiment of this disclosure further provides a computer device. The computer device may be a terminal, a server, or the like. FIG. 16 is a schematic structural diagram of a computer device according to an embodiment of this disclosure. Specifically,

the computer device may include components such as a processor 401 with one or more processing cores, a memory 402 with one or more computer-readable storage media, a power supply 403, and an input unit 404. A person skilled in the art may understand that the structure of the terminal device shown in FIG. 16 does not constitute a limitation on the terminal device, which may include more or fewer components than those illustrated, or some components may be combined, or a different component deployment may be used.

The processor 401 is a control center of the computer device, is connected to various parts of the entire computer device by using various interfaces and lines, and by running or executing a software program and/or a module stored in the memory 402 and invoking data stored in the memory 402, performs various functions and data processing of the computer device. In some embodiments, the processor 401 may include one or more processing cores. Preferably, the processor 401 may integrate an application processor and a modem. The application processor mainly processes an operating system, a user interface, an application, and the like. The modem mainly processes wireless communication. The foregoing modem may not be integrated into the processor 401.

The memory 402 may be configured to store a software program and a module. The processor 401 runs the software program and the module stored in the memory 402, to implement various functional applications and data processing. The memory 402 may mainly include a program storage area and a data storage area. The program storage area may store an operating system, an application required by at least one function (such as a sound playback function and an image display function), and the like. The data storage area may store data created according to use of the computer device, and the like. The memory 402 may include a high-speed random access memory, and may also include a non-volatile memory, for example, one or more magnetic storage devices, a flash memory, or another non-volatile solid-state storage device. Correspondingly, the memory 402 may further include a memory controller, so as to provide access of the processor 401 to the memory 402.

The computer device further includes the power supply 403 that supplies power to the components. Preferably, the power supply 403 may be logically connected to the processor 401 by using a power management system, thereby implementing functions such as charging, discharging, and power consumption management by using the power management system. The power supply 403 may further include any components such as one or more of a direct current or alternating current power supply, a re-charging system, a power failure detection circuit, a power supply converter or inverter, and a power state indicator.

The computer device may further include the input unit 404. The input unit 404 may be configured to receive inputted digit or character information, and generate keyboard, mouse, joystick, optical, or track ball signal input related to user setting and function control.

Although not shown, the computer device may further include a display unit and the like, which are not described in detail herein. Specifically, in this embodiment, the processor 401 in the computer device may load, according to the following instructions, executable files corresponding to processes of one or more applications into the memory 402, and the processor 401 runs the applications stored in the memory 402, to implement various functions as follows:

acquiring target limb information, acquiring user identification information corresponding to the target limb information, and acquiring custom limb configuration information matching the user identification information; and matching the target limb information with limb information included in the custom limb configuration information, to obtain limb information matching the target limb information, selecting a target object according to the limb information matching the target limb information, acquiring biological information matching the user identification information, and performing a corresponding operation on the target object based on the biological information.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In the foregoing embodiments, the descriptions of the embodiments have different focuses, and for a part that is not described in detail in an embodiment, reference may be made to the detailed description of the information processing method above. Details are not described herein again.

In addition, an embodiment of this disclosure further provides a storage medium, configured to store a computer program. The computer program is configured for performing the method provided in the foregoing embodiments.

An embodiment of this disclosure further provides a computer program product including a computer program which, when run on a computer, causes a computer to perform the method provided in the foregoing embodiments.

A person of ordinary skill in the art may understand that all or some steps of the methods in the foregoing embodiments may be implemented by using computer instructions, or implemented by computer instructions controlling relevant hardware, and the computer instructions may be stored in a computer-readable storage medium (i.e., the storage medium) and loaded and executed by a processor. Accordingly, an embodiment of this disclosure provides a storage medium storing a computer program. The computer program may include computer instructions. The computer program can be loaded by a processor, to perform any information processing method provided in the embodiments of this disclosure.

For specific implementations of the above operations, refer to the foregoing embodiments. Details are not described herein again.

The storage medium may include: a read-only memory (ROM), a random access memory (RAM), a magnetic disk, an optical disc, or the like.

Since the instructions stored in the storage medium may perform the steps in any information processing method provided in the embodiments of this disclosure, beneficial effects that can be achieved by any information processing method provided in the embodiments of this disclosure can be achieved. For details, reference may be made to the foregoing embodiments. Details are not described herein again.

An information processing method and apparatus, a computer device, a storage medium, and a computer program product provided in the embodiments of this disclosure are described above in detail. Although the principles and implementations of this disclosure are described by using specific examples in this specification, the descriptions of the foregoing embodiments are merely intended to help understand the method of this disclosure. Meanwhile, a person skilled in the art may make modifications to the specific implementations and the application range according to the idea of this disclosure. In conclusion, the content of this specification is not construed as a limitation on this disclosure.

What is claimed is:

1. An information processing method comprising:
acquiring target limb information and user identification information;
acquiring customized limb configuration information that matches the user identification information;
matching the target limb information with reference limb information in the customized limb configuration information;
selecting a target object according to the reference limb information;
acquiring biometric information that matches the user identification information; and
performing an operation with the target object based on the biometric information.

2. The information processing method according to claim 1, wherein the reference limb information indicates a first limb action and a second limb action, and the selecting the target object comprises:
displaying an information selection interface based on the first limb action matching the target limb information; and
selecting the target object in the information selection interface based on the second limb action.

3. The information processing method according to claim 2, wherein the selecting the target object in the information selection interface comprises:
obtaining an updated information selection interface based on performing a moving or zooming operation on the information selection interface according to the second limb action; and
selecting the target object in the updated information selection interface.

4. The information processing method according to claim 1, wherein the biometric information comprises palm information, and the acquiring biometric information comprises:
acquiring a color palm image and an infrared palm image that match the user identification information;
obtaining a fused palm image based on fusing the color palm image and the infrared palm image; and
obtaining the palm information based on performing palm recognition according to the fused palm image.

5. The information processing method according to claim 4, wherein the obtaining the palm information comprises:
extracting palmprint information and a palm vein feature of a palm from the fused palm image; and
generating the palm information based on the palmprint information and the palm vein feature.

6. The information processing method according to claim 1, wherein the acquiring the target limb information comprises:
acquiring an activation instruction, and activating a limb collection device based on the activation instruction;
collecting a plurality of frames of candidate limb images by using the limb collection device; and
obtaining the target limb information based on performing limb recognition on the plurality of frames of candidate limb images.

7. The information processing method according to claim 6, wherein the acquiring the activation instruction comprises at least one of:
detecting distance information between a living body and the limb collection device, and generating the activation instruction when the distance information is less than a preset distance threshold; or
generating the activation instruction when a face image or a target gesture is detected.

8. The information processing method according to claim 1, wherein the acquiring the user identification information comprises at least one of:
extracting feature data of the target limb information, and determining the user identification information according to the feature data; or
acquiring user indication information indicating the target limb information, and determining the user identification information according to the user indication information.

9. The information processing method according to claim 1, wherein the acquiring customized limb configuration information comprises:
querying whether the customized limb configuration information that matches the user identification information is stored in a local device;
acquiring the customized limb configuration information corresponding to the target limb information from the local device when the customized limb configuration information that matches the user identification information is stored in the local device; and
acquiring the customized limb configuration information corresponding to the target limb information from a server when the customized limb configuration information that matches the user identification information is not stored in the local device.

10. The information processing method according to claim 1, comprising:
receiving a configuration instruction, and entering a configuration mode based on the configuration instruction;
receiving, in the configuration mode, inputted customized limb information, and acquiring the user identification information corresponding to the customized limb information; and
generating the customized limb configuration information according to the user identification information and the customized limb information.

11. The information processing method according to claim 1, wherein the matching the target limb information comprises:
acquiring a similarity between target gesture feature information and gesture feature information based on comparing the target gesture feature information in the target limb information with the gesture feature information of the limb information in the customized limb configuration information; and
determining gesture limb information corresponding to the gesture feature information, when the similarity is greater than a preset similarity threshold, to be the reference limb information matching the target limb information.

12. The information processing method according to claim 1, wherein the performing the operation comprises:
acquiring payment information corresponding to the target object based on the biometric information; and
performing a payment operation with the target object based on the payment information.

13. The information processing method according to claim 1, wherein the performing the operation comprises:
acquiring link information corresponding to the target object based on the biometric information;
acquiring a playback file of the target object based on the link information; and
playing back the playback file.

14. The information processing method according to claim 1, wherein the performing the operation comprises:
generating a copy instruction based on the biometric information; and
performing a copy operation with the target object in response to the copy instruction.

15. An information processing method comprising:
obtaining target limb information based on collecting external limb information by using an information collector of a palm scanning device;
when user identification information corresponding to the target limb information exists, acquiring, by using an application of the palm scanning device, customized limb configuration information matching the user identification information;
matching the target limb information with reference limb information in the customized limb configuration information;
selecting, in response to the limb information matching the target limb information, a target object from selectable objects provided by the palm scanning device;
collecting, by using the information collector, palm information matching the user identification information;
acquiring, in response to a message indicating successful verification on the palm information, payment information corresponding to the target object by using the palm scanning device; and
performing a payment operation based on the payment information.

16. The information processing method according to claim 15, wherein the reference limb information indicates a first limb action and a second limb action, and the selecting the target object comprises:
displaying, based on the first limb action matching the target limb information, an information selection interface by using a display screen of the palm scanning device;
obtaining an updated information selection interface based on performing a moving or zooming operation on the information selection interface in response to the second limb action; and
selecting, in the updated information selection interface, the target object from the selectable objects provided by the palm scanning device.

17. An information processing apparatus comprising:
processing circuitry configured to:
acquire target limb information and user identification information;
acquire customized limb configuration information that matches the user identification information;
match the target limb information with reference limb information in the customized limb configuration information;
select a target object according to the reference limb information;
acquire biometric information that matches the user identification information; and
perform an operation with the target object based on the biometric information.

18. The information processing apparatus according to claim 17, wherein the reference limb information indicates a first limb action and a second limb action and the processing circuitry is configured to:
display an information selection interface based on the first limb action matching the target limb information; and
select the target object in the information selection interface based on the second limb action.

19. The information processing apparatus according to claim 18, wherein the processing circuitry is configured to:
obtain an updated information selection interface based on performing a moving or zooming operation on the information selection interface according to the second limb action; and
select the target object in the updated information selection interface.

20. The information processing apparatus according to claim 17, wherein the biometric information comprises palm information, and the processing circuitry is configured to:
acquire a color palm image and an infrared palm image that match the user identification information;
obtain a fused palm image based on fusing the color palm image and the infrared palm image; and
obtain the palm information based on performing palm recognition according to the fused palm image.
